(19) United States
(12) Patent Application Publication
(10) Pub. No.: US 2026/0347149 A1
(43) Pub. Date: Nov. 5, 2026

(54) ELEVATOR CAR ASSEMBLY FOR A DOUBLE-DECK ELEVATOR

(71) Applicant: INVENTIO AG, Hergiswil (CH)

(72) Inventors: Stefan Weber, Niederwil (CH); Dragan Gavric, Brunnen (CH)

(21) Appl. No.: 19/100,099

(22) PCT Filed: Sep. 5, 2023
(86) PCT No.: PCT/EP2023/074217

§ 371 Date: Jan. 30, 2025

(30) Foreign Application Priority Data
Sep. 15, 2022 (EP) 22195749.1

(51) Int. Cl. B66B 11/02

(52) U.S. Cl. CPC B66B 11/0273; B66B 11/022

(57) ABSTRACT

An elevator car assembly for a double-deck elevator having an elevator car frame which can be displaceably mounted in a shaft between a plurality of floors; two elevator cars connected to the elevator car frame so as to be displaceable together with the elevator car frame and optionally arranged one above the other, wherein a spacing between the elevator cars arranged one above the other can be adjusted by displacing the elevator cars relative to one another by means of an actuator; a vibration damper comprising a damping mass and an elongated damper spring, wherein the damping mass is connected to a free end of the damper spring, and the other damper spring end is connected to an elevator car assembly component susceptible to vibrations, wherein the damping mass and the damper spring are adjusted to one another such that the vibration damper generates desired vibrations counteracting undesirable vibrations.

The present invention relates to an elevator car assembly for a double-deck elevator. Furthermore, the invention relates to a double-deck elevator, a method for adjusting a vibration damper of an elevator car assembly for a double-deck elevator, and a control unit for carrying out this method.

In addition to single-cabin elevators, so-called double-decker or double-deck elevators can be used to transport people and/or objects between floors of a building. A double-deck elevator is basically characterized by an elevator car frame in which two elevator cars or elevator cabins are arranged one above the other. By moving the elevator car frame with the elevator cars arranged therein, the elevator cars can be moved together and thus stop simultaneously at two floors located one above the other.

Because the floor heights may vary within a building, double-deck elevators are often equipped with an adjustment mechanism with which the vertical spacing between the two elevator cars can be adapted, for example automatically during the trip to the next stop.

The adjustment mechanism may, for example, comprise an electric spindle drive. When one or both of the elevator cars are adjusted vertically using such a drive, undesirable vibrations of the entire elevator car assembly or parts thereof, in particular the elevator car frame and/or the driven elevator car, may occur in certain situations, for example at certain drive speeds, which may manifest themselves as vibrations and/or noise and thus reduce riding comfort.

EP 1 074 503 B1 shows an example of a double-deck elevator with two spindle drives for vertical adjustment of two elevator cars within an elevator car frame.

EP 3 176 121 B1 describes an elevator car assembly consisting of an elevator car and an elevator car frame which is connected to the elevator car via a damper. The damper serves to dampen vibrations that are transmitted via guide rails to the elevator car frame and from there to the elevator car during operation of the elevator. For this purpose, the damper is attached with its first end to the floor of the elevator car and with its second end to the elevator car frame. The two ends are connected to one another via a damping element, e.g., made of rubber.

There may therefore be a need for an improved elevator car assembly for a double-deck elevator with which undesirable vibrations, for example in the form of vibrations and/or noise, can be reduced or limited during operation of the double-deck elevator, in particular during vertical adjustment of the two elevator cars relative to one another.

In addition, there may be a need for a method that allows an automatic adaptation of a vibration damper of such a vibration-damped elevator car assembly to different operating conditions.

Furthermore, there may be a need for a corresponding control unit and a corresponding double-deck elevator.

These needs can be met by the subject matter of the independent claims. Advantageous embodiments are defined in the dependent claims, in the following description and in the accompanying drawings.

A first aspect of the invention relates to an elevator car assembly for a double-deck elevator. The elevator car assembly comprises: an elevator car frame which can be displaceably mounted in a shaft between multiple floors; two elevator cars which are connected to the elevator car frame in such a way that they can be displaced together with the elevator car frame and-when the elevator car frame is displaceably mounted in the shaft between the floors-are arranged one above the other, wherein a spacing between the elevator cars arranged one above the other can be adjusted by displacing the elevator cars relative to one another by means of an actuator; a vibration damper which comprises a damping mass and an elongated damper spring, wherein the damping mass is connected to a free end of the damper spring, and the damper spring is connected at its other end to a component of the elevator car assembly susceptible to vibrations, wherein the damping mass and the damper spring are adjusted to one another in such a way that the vibration damper generates desired vibrations when the actuator is operated which counteract, i.e., mitigate or eliminate, undesirable vibrations of the component susceptible to vibrations.

When in an operational state, the elevator car frame can be mounted to be vertically displaceable between floors.

The elevator car frame can be understood as a frame-like structure consisting of a plurality of supports and/or support structures. For example, the elevator car frame can be guided in the operational state via guide shoes and/or rollers along at least one guide rail anchored in the shaft.

In the simplest case, the elevator car frame can, for example, be constructed from two (horizontal) cross members and two (vertical) longitudinal members which are connected via the cross members to form a frame. The elevator car frame can also have three (horizontal) cross beams. The elevator cars can be arranged one above the other within this frame. For example, each longitudinal member can be guided on a guide rail.

As mentioned at the outset, the two elevator cars can be moved by moving the elevator car frame along the guide rail(s) together in the elevator shaft and thus stop simultaneously at two floors located (directly) one above the other. By means of the actuator, for example in the form of one or more spindle, chain or gear rack drives, it is possible to adapt the vertical spacing between the elevator cars to the vertical spacing between two floors (directly) one above the other at which the elevator cars are to stop at the same time.

It is possible that only one of the elevator cars can be moved relative to the elevator car frame by means of the actuator, while the other car is firmly connected to the elevator car frame. Alternatively, both elevator cars can be moved relative to the elevator car frame by means of the actuator or by means of a plurality of actuators.

The actuator can, for example, comprise an electric drive motor and a gearbox that couples a drive shaft of the drive motor to a spindle. The spindle can be rotatably mounted in a spindle nut, wherein the spindle nut can be fastened in a suitable manner to one of the elevator cars arranged one above the other, for example to the lower elevator car. By rotating the spindle, the position of the spindle nut changes relative to the longitudinal direction of the spindle depending on the direction of rotation. This also changes the spacing between the elevator cars arranged one above the other. The actuator can additionally comprise a braking system, in particular a redundant braking system, using spring-applied brakes.

The term “vibration damper” can be understood as a pendulum-like vibration damper braced on one side. The damping mass and the damper spring form a mass-spring system with a specific natural frequency which is adjusted to the resonance frequencies of the component(s) susceptible to vibration(s) to which it is attached in such a way that undesirable vibrations of this/these component(s) are canceled out or attenuated by (desired) vibrations of the mass-spring system according to its natural frequency. The term “spring” can encompass various types of elastically deformable bodies. In particular, the damper spring can be made of at least one elastically deformable material, for example spring steel or various metallic and/or non-metallic elastically deformable materials, and/or with a geometry promoting the elastic deformation of the damper spring. For example, the damper spring can also be designed with a spiral spring or a helical spring.

Such a vibration damper can have a very simple structure, especially if it is designed as a passive damper, and can therefore be easily installed or removed. In addition, such a vibration damper is very robust and, in contrast to rubber dampers, practically maintenance-free.

The vibration damper can have a fixed natural frequency or multiple fixed natural frequencies. An embodiment of the vibration damper is also possible that allows a change in its natural frequency/frequencies, for example by means of a separate servomotor that is designed to change the position of the damping mass relative to the damper spring (see also below).

In order to achieve the greatest possible damping effect, the vibration damper should be placed as close as possible to the center of gravity of the component susceptible to vibrations.

The vibration damper may be mounted suspended, standing or lying down, for example.

The vibration damper, or more precisely the connected end of the damper spring, can also be connected to multiple components susceptible to vibrations of the elevator car assembly at the same time.

The elevator car assembly may also comprise two or more than two, for example four, six or eight vibration dampers which may be connected to the same vibration-susceptible component and/or to different vibration-susceptible components.

It is possible that the damper springs of different vibration dampers protrude from the component susceptible to vibrations in different, for example opposite, directions. For example, one of the damper springs can protrude upward so that the given damping mass stands on the damper spring, whereas another of the damper springs can protrude downward so that the given damping mass is suspended on the damper spring. Alternatively, the damper springs can correspondingly protrude in different horizontal directions.

A second aspect of the invention relates to a preferably computer-implemented method for adjusting a vibration damper of an elevator car assembly for a double-deck elevator. The elevator car assembly can be the elevator car assembly according to an embodiment of the first aspect of the invention described above or below, in which the damping mass is movable between different longitudinal positions in the longitudinal direction of the damper spring, and the vibration damper further comprises a servomotor for adjusting the damping mass between the longitudinal positions. The method comprises: receiving vibration data that indicate current frequencies of the undesirable vibrations; determining a selected longitudinal position from the various longitudinal positions between which the damping mass is movable in the longitudinal direction of the damper spring, wherein the vibration damper has a natural frequency adjusted to the current frequencies when the damping mass is in the selected longitudinal position; generating a control command to control the actuator so that the damping mass is adjusted to the selected longitudinal position.

The method allows automatic adaptation of the natural frequency/frequencies of the vibration damper to different environmental conditions. This allows the undesirable vibrations under different environmental conditions to be attenuated.

The vibration data may have been generated using a suitable sensor, for example using an inertial sensor for measuring an acceleration and/or rotation rate of the component susceptible to vibrations with respect to one or more, preferably three, spatial axes.

A computer program, which comprises instructions that cause a processor of the control unit to carry out the method described above and below when the computer program is executed by the processor, can be stored in the memory of the control unit.

For example, a lookup table can also be stored in the memory of the control unit, which table assigns different longitudinal positions of the damping mass to different resonance frequency ranges of the component susceptible to vibrations. Each longitudinal position can correspond to a specific natural frequency range of the vibration damper which is suitably adjusted to the corresponding resonance frequency range in order to allow the undesirable vibrations of the component susceptible to vibrations to be attenuated or even completely eliminated by corresponding counter-vibrations of the vibration damper. For example, the natural frequency range and the resonant frequency range may at least partially include the same frequencies.

Features of the method described above and below may also be features of the control unit (and vice versa).

A third aspect of the invention relates to a control unit with a processor that is configured to carry out the method described above and below. The control unit can comprise hardware and/or software modules. In addition to the processor, the control unit can comprise a memory and data communication interfaces for wireless and/or wired data communication with peripheral devices. The control unit may, for example, be a hardware and/or software component of a higher-level elevator control system. Alternatively, the control unit may be a hardware component of the elevator car assembly. If the double-deck elevator comprises a plurality of elevator car assemblies, each elevator car assembly may, for example, comprise such a control unit as its own hardware component.

A fourth aspect of the invention relates to a double-deck elevator. The double-deck elevator comprises: a shaft; the elevator car assembly described above and below, wherein the elevator car frame is displaceably mounted in the shaft between multiple floors.

Embodiments of the invention can be regarded, without limiting the invention, as being based upon the ideas and findings described below.

According to one embodiment, the component susceptible to vibrations may be a first of the elevator cars. During operation of the actuator, undesirable vibrations of the actuator and/or the elevator car frame can be transmitted to one of the elevator cars, in particular to the elevator car driven by the actuator. By mechanically coupling the vibration damper to the relevant elevator car, these vibrations can be dampened particularly effectively. This allows annoying vibrations and/or noises from the elevator car to be avoided, which improves riding comfort.

According to one embodiment, the damper spring may be connected at its other end to a floor structure of the first elevator car. This means that the vibration damper may be placed as close as possible to the center of gravity of the first elevator car. This improves vibration damping compared to designs in which the vibration damper is placed further away from the center of gravity, for example on a ceiling structure or side wall of the first elevator car. The floor structure can be a load-bearing structure. The floor structure can therefore support a large part of the weight of the first elevator car (for example, a cabin of the first elevator car can rest on the floor structure).

According to one embodiment, the first elevator car may be a lower one of the elevator cars arranged one above the other and/or may be mechanically coupled to the actuator, i.e., may be displaced relative to the elevator car frame by means of the actuator. In practical tests with an elevator car assembly in which the lower elevator car is the elevator car driven by the actuator, it was shown that this embodiment allows particularly effective vibration damping. The first and/or lower elevator car may, for example, be mechanically coupled to the actuator via its floor structure.

According to one embodiment, the component susceptible to vibrations may be the elevator car frame or the actuator. In certain cases, for example for reasons of space, it may be useful to attach the vibration damper to a component other than one of the elevator cars. The elevator car frame or the actuator is particularly suitable for this purpose because a significant portion of the undesirable vibrations is usually transferred from these components to other components of the elevator car assembly. For example, the actuator may be attached to the elevator car frame and, depending on its speed, vibrate at an excitation frequency that causes the elevator car frame (and possibly one or each of the elevator cars connected thereto) to vibrate in an undesirable manner. This can be avoided by attaching the vibration damper to the actuator itself or to the elevator car frame.

It is also conceivable that at least a first vibration damper is attached to one or each of the elevator cars, at least a second vibration damper is attached to the elevator car frame, and at least a third vibration damper is attached to the actuator.

According to one embodiment, the component susceptible to vibrations may be a longitudinal beam of the elevator car frame. In this case, the damper spring may be attached to the longitudinal beam at its other end directly or indirectly, for example via an arm protruding from the longitudinal beam. The longitudinal beam may, for example, have one or more car guide rails for guiding one of or both of the cars when displaced by means of the actuator.

It is also conceivable that the elevator car frame comprises a guide portion for guiding the elevator car frame along at least one guide rail anchored in the shaft during (vertical) displacement between the floors. In this case, the damper spring can be connected to the guide portion at its other end. The guide portion may be formed, for example, by one or more, preferably two, vertical longitudinal beams which can be coupled to the guide rail (or guide rails) in the operational state of the elevator car assembly, for example via guide shoes and/or rollers. When the elevator car frame is displaced in the shaft, undesirable vibrations can also be transmitted from the guide rail (or guide rails) via the guide portion to the elevator car frame and from there to one or each of the elevator cars. The transmission of these additional vibrations via the elevator car frame can be effectively prevented if the vibration damper is attached to the guide portion itself.

According to one embodiment, the damping mass can be movable between different longitudinal positions in the longitudinal direction of the damper spring. In this case, the vibration damper may further comprise a servomotor for adjusting the damping mass between the longitudinal positions. In other words, the actuator may be designed to move the damping mass and the damper spring relative to one another in the longitudinal direction of the damper spring. The servomotor can be electrically controllable by a control unit of the double-deck elevator. For example, the actuator may be designed as an electric, hydraulic or pneumatic drive or a combination of at least two of these examples. This allows for easy automatic adaptation of the natural frequency/frequencies of the vibration damper to changes in the frequencies of the undesirable vibrations, for example when the rotational speed of the actuator for displacing the elevator cars changes.

According to one embodiment, the damper spring may comprise a tubular portion. The free end and the other end of the damper spring can be ends of the tubular portion. In the simplest case, the damper spring may be formed by a single tube.

According to one embodiment, the damping mass may be formed by a body with an opening for passage of the damper spring, for example in the form of a tube. In this case, an inner contour of the opening may be adapted to an outer contour of the damper spring in such a way that the body and the damper spring can be displaced relative to one another in the longitudinal direction of the damper spring with sufficient accuracy. This allows for easy and precise adjustment of the longitudinal position of the damping mass (see also above).

The body may, for example, be cylindrical or disk-shaped and/or made up of one or more pieces. For example, the body may be formed by a stack of multiple disks having central openings. This allows easy adjustment of the weight of the damping mass by adding or removing individual disks. In addition, such a rotationally symmetrical design of the body causes the vibration damper to behave the same or similarly when vibrating in different vibration directions.

According to one embodiment, the free end of the damper spring may protrude vertically or horizontally from the component susceptible to vibrations if the elevator car frame is displaceably mounted in the shaft between the floors.

In other words, the free end may protrude downward or upward, for example from the floor structure of one of the elevator cars, wherein the damping mass is suspended from the damper spring in the first case and stands on the damper spring in the second case.

The damper spring in this case therefore has a substantially vertical longitudinal direction. Alternatively, the free end may protrude to the left or right, for example toward or away from the center of the floor structure. The damper spring in this case therefore has a substantially horizontal longitudinal direction.

According to one embodiment, the elevator car assembly may further comprise: a further vibration damper that comprises a damping mass and an elongated damper spring, wherein the damping mass is connected to a free end of the damper spring, and the damper spring is connected at its other end to a component susceptible to vibrations of the elevator car assembly, wherein the damping mass and the damper spring are adjusted to one another such that the further vibration damper generates desired vibrations during operation of the actuator which counteract undesirable vibrations of the component susceptible to vibrations, i.e., which attenuate or eliminate them.

The vibration damper and the additional vibration damper may preferably be constructed identically.

The elevator car assembly may also comprise two or more than two additional vibration dampers.

This makes it possible to place a plurality of vibration dampers at multiple suitable locations in the elevator car assembly. This may further improve the effectiveness of the vibration damping.

According to one embodiment, the vibration damper and the further vibration damper (or the further vibration dampers) may be attached at different locations on the same component susceptible to vibrations.

For example, the various vibration dampers may be arranged evenly distributed around the center of gravity of the same component susceptible to vibrations.

Alternatively, the different vibration dampers may be connected to different components of the elevator car assembly which are susceptible to vibrations.

For example, the different damper springs may be located in the same horizontal or vertical plane. Additionally or alternatively, the longitudinal axes of the damper springs may be aligned parallel to one another. A collinear arrangement of the longitudinal axes of the damper springs is also possible.

In addition, as mentioned above, the various damper springs may protrude from the given component (or given components) in opposite directions.

Thus, the effectiveness of the vibration damping can be further improved.

According to one embodiment, the double-deck elevator may further comprise the control unit described above and below and a device for determining the current frequencies of the undesirable vibrations of the component of the elevator car assembly susceptible to vibrations. This allows automatic adaptation of the vibration damper of the elevator car assembly to different environmental conditions.

Embodiments of the invention will be described below with reference to the accompanying drawings. Neither the description nor the drawings are to be understood as limiting the invention.

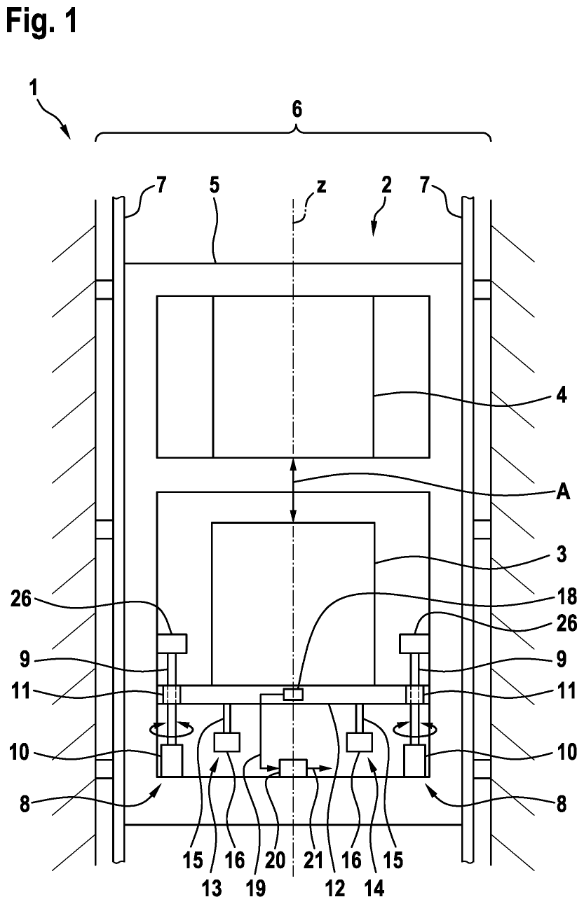

FIG. 1 shows a double-deck elevator according to one embodiment of the invention.

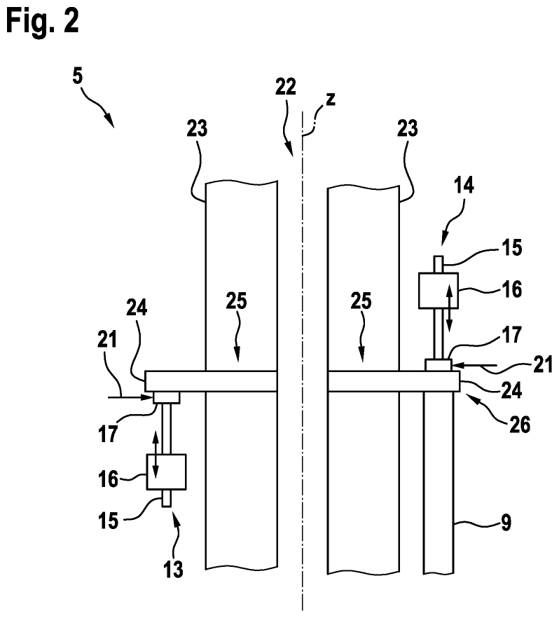

FIG. 2 shows a side view of an elevator car frame of an elevator car assembly according to one embodiment of the invention.

The drawings are purely schematic and are not to scale. The same reference signs in different drawings indicate the same or equivalent features.

FIG. 1 shows components of a double-deck elevator 1. The double-deck elevator 1 comprises an elevator car assembly 2 consisting of a first elevator car 3, a second elevator car 4 and an elevator car frame 5 which is displaceably mounted in a shaft 6 between multiple floors of a building in the direction of a vertical axis z.

Vertically running guide rails 7 may be anchored in the shaft 6 which guide the elevator car frame 5 in the z-direction on one side or, as is the case here, on both sides.

The elevator cars 3, 4 are arranged one above the other in the elevator car frame 5 and separated from one another by a vertical spacing A. In this example, the first elevator car 3 is a lower one of the two elevator cars 3, 4.

By moving the elevator car frame 5 in the elevator shaft 6 along the guide rails 7, the two elevator cars 3, 4 can be moved together and thus stop simultaneously at two adjacent floors, i.e., directly one above the other.

The floor heights can vary within the building. For example, a vertical spacing between two adjacent floors can decrease as the height of the building increases, which can be the case with high-rise buildings in particular. It should therefore be possible to correspondingly adapt the vertical spacing A between the two elevator cars 3, 4.

For this purpose, in this example the lower, first elevator car 3 is mounted on the elevator car frame 5 so as to be displaceable in the z-direction. The second elevator car 4, however, is firmly connected to the elevator car frame 5.

The vertical adjustment of the first elevator car 3 can take place, for example, by means of two (identical) spindle drives 8 as an actuator, each of which comprises a spindle 9 and a drive unit 10 for driving, i.e., motorized rotation of, the spindle 9. Each drive unit 10 may, for example, comprise an electric drive motor, a gear coupling the drive motor to the given spindle 9, and spring-applied brakes. On each spindle 9 sits a spindle nut 11 which is connected here to a supporting floor structure 12 of the first elevator car 3. By rotating the spindles 9, the spindle nuts 11 are displaced in the longitudinal direction of the spindles 9, i.e., in the z-direction, whereby the first elevator car 3 is either lowered or raised, i.e., the spacing A becomes larger or smaller, depending on the direction of rotation. In this case, certain components susceptible to vibrations of the elevator car assembly 2, in particular the lower, driven elevator car 3, can be made to oscillate undesirably, which can manifest as disturbing vibrations and/or disturbing noises.

In order to eliminate or reduce these undesirable vibrations, the elevator car assembly 2 in this example further comprises a first vibration damper 13 and a second vibration damper 14 which here-similar to a pendulum-are attached to the floor structure 12 suspended downward. The first vibration damper 13 is attached to the floor structure 12 at the front left, and the second vibration damper 14 is attached at the rear right. The two vibration dampers 13, 14 therefore lie diagonally opposite one another and are thus evenly distributed around a center of gravity of the lower elevator car 3, which is beneficial to the effectiveness of the vibration damping.

The vibration dampers 13, 14 may also be attached standing or lying and/or in orientations differing from each other on the floor structure 12 or another component susceptible to vibration, such as the elevator car frame 5 (see FIG. 2).

The elevator car assembly 2 may also comprise only one vibration damper or more than two, for example at least four, at least six or at least eight vibration dampers.

Each vibration damper 13, 14 is formed by an elongated damper spring 15, for example a simple tube, with a defined stiffness and by a damping mass 16 with a defined weight. The damping mass 16 sits on a free end of the damper spring 15, while the other end of the damper spring 15 is attached to the floor structure 12, for example screwed or welded thereto. The damping mass 16 may in particular be formed by a single-piece or multi-piece cylindrical body.

Each vibration damper 13, 14 is adjusted in such a way-more precisely the damper spring 15 and the damping mass 16 of each vibration damper 13, 14 are adjusted to one another in such a way-that it vibrates with a certain natural frequency or with natural frequencies within a certain frequency range when the spindle drives 8 are operating, i.e., when the electric motors of the drive units 10 rotate the spindles 9 at a certain rotational speed. These desired vibrations of the vibration dampers 13, 14 interact with the undesirable vibrations in such a way that the undesirable vibrations are noticeably attenuated, at least to such an extent that no disturbing vibrations and/or no disturbing noises can be perceived any more.

In order to adjust the vibration dampers 13, 14, the given damping mass 16 may, for example, be mounted in different longitudinal positions in the longitudinal direction of the given damper spring 15, in this case in the z-direction.

It is particularly advantageous if the damping mass 16 is displaceably mounted on the damper spring 15 between the longitudinal positions. In this case, the damping mass 16 can be adjustable between the longitudinal positions, for example by means of an electric actuator 17 (see FIG. 2). This allows automatic adjusting of the vibration dampers 13, 14.

For this purpose, current frequencies or—additionally—other relevant properties of the undesirable vibrations, such as their amplitude, may be determined using a suitable vibration sensor 18, for example an inertial sensor arranged on the floor structure 12 or directly on the first elevator car 3.

The vibration data 19 generated in this way are received by a control unit 20 which evaluates the vibration data 19 in order to determine a suitable longitudinal position for each damping mass 16 and generates a corresponding control command 21 for each actuator 17, which command causes said actuator to adjust the given damping mass 16 to the given longitudinal position. The vibration dampers 13, 14 then generate desired vibrations which counteract the undesirable vibrations corresponding to the current frequencies.

FIG. 2 shows an alternative arrangement of the vibration dampers 13, 14 on the elevator car frame 5, more precisely on a lateral guide portion 22 of the elevator car frame 5, which is formed here by two parallel longitudinal beams 23 of the elevator car frame 5.

It is possible that the first elevator car 3 is displaceably mounted on one or both of the longitudinal beams 23 in the z-direction via one or more car guide rails (not shown). If the first elevator car 3 is supported on both sides as shown in FIG. 1, the elevator car frame 5 can have such a guide portion 22 on each of two opposite sides.

One of the vibration dampers 13, 14 is attached to each longitudinal beam 23 via its given damper spring 15. In this example, the first vibration damper 13 is mounted in suspension, whereas the second vibration damper 14 is mounted standing.

Each vibration damper 13, 14 is fastened via its given damper spring 15 to one of two arms 24, each of which protrudes from one of the longitudinal beams 23 and is fastened to the given longitudinal beam 23 via a fastening device 25. The fastening device 25 may be formed, for example, by a screw connection and/or welding.

The arm 24 of the second vibration damper 14 also comprises a bearing device 26 (see also FIG. 1) which rotatably supports an upper end of the spindle 9. The second vibration damper 14 and the spindle 9 may, as in this case, be arranged on opposite sides of the arm 24.

The arms 24 may be arranged substantially at the same height when viewed in the z-direction. However, the arms 24 may also have positions differing from each other in the z-direction.

Additionally or alternatively, at least one vibration damper 13, 14 may be attached to at least one of the spindle drives 18, for example to the drive unit 10.

Finally, it should be noted that terms such as “have,” “comprise,” “include,” “with,” etc. do not exclude other elements or steps, and indefinite articles such as “a” or “an” do not exclude a plurality. Furthermore, it should be noted that features or steps that are described with reference to one of the above embodiments may also be used in combination with features or steps that are described with reference to other of the above embodiments. Reference signs in the claims should not be understood as limiting.

1. An elevator car assembly for a double-deck elevator, the elevator car assembly comprising:
an elevator car frame which can be displaceably mounted in a shaft between multiple floors;
two elevator cars which are connected to the elevator car frame in such a way that they can be displaced together with the elevator car frame, and when the elevator car frame is mounted so as to be displaceable in the shaft between the floors, are arranged one above the other, wherein a spacing between the elevator cars arranged one above the other can be adjusted by displacing the elevator cars relative to one another by means of an actuator; and
a vibration damper that comprises a damping mass and an elongated damper spring (16), wherein the damping mass-(16) is connected to a free end of the damper spring, and the damper spring is connected at its other end to a component of the elevator car assembly susceptible to vibration, wherein the damping mass and the damper spring are adjusted to one another such that the vibration damper generates desired vibrations during operation of the actuator that counteract undesirable vibrations of the component susceptible to vibration.

2. The elevator car assembly according to claim 1, wherein the component susceptible to vibrations is a first of the elevator cars.

3. The elevator car assembly according to claim 2, wherein the damper spring is connected at its other end to a floor structure of the first elevator car.

4. The elevator car assembly according to claim 2, wherein the first elevator car is a lower one of the elevator cars arranged one above the other and/or is mechanically coupled to the actuator.

5. The elevator car assembly according to claim 1, wherein the component susceptible to vibrations is the elevator car frame or the actuator.

6. The elevator car assembly according to claim 5, wherein the component susceptible to vibrations is a longitudinal beam of the elevator car frame.

7. The elevator car assembly according to claim 1,
wherein the damping mass is movable between different longitudinal positions in the longitudinal direction of the damper spring; and
wherein the vibration damper further comprises a servomotor for adjusting the damping mass between the longitudinal positions.

8. The elevator care assembly according to claim 1,
wherein the damper spring comprises a tubular portion, wherein the free end and the other end of the damper spring are ends of the tubular portion; and/or
wherein the damping mass is formed by a body having an opening for the passage of the damper spring.

9. The elevator car assembly according to claim 1, wherein the free end of the damper spring protrudes vertically or horizontally from the component susceptible to vibrations when the elevator car frame is mounted so as to be displaceable within the shaft between the floors.

10. The elevator car assembly according to claim 1, further comprising:
a further vibration damper which comprises a damping mass and an elongated damper spring, wherein the damping mass is connected to a free end of the damper spring, and the damper spring is connected at its other end to a component of the elevator car assembly susceptible to vibrations, wherein the damping mass and the damper spring are adjusted to one another such that the further vibration damper generates desired vibrations during operation of the actuator which counteract undesirable vibrations of the component susceptible to vibrations.

11. The elevator car assembly according to claim 10, wherein the vibration damper and the further vibration damper are attached at different locations on the same component susceptible to vibrations.

12. A method for adjusting a vibration damper of an elevator car assembly for a double-deck elevator, wherein the elevator car assembly is the elevator car assembly according to claim 7, wherein the method comprises:
receiving vibration data that indicates current frequencies of the undesirable vibrations;
determining a selected longitudinal position from the various longitudinal positions between which the damping mass is movable in the longitudinal direction of the damper spring using the vibration data, wherein the vibration damper has a natural frequency adjusted to the current frequencies when the damping mass is in the selected longitudinal position; and
generating a control command to control the actuator motor so that the damping mass is set to the selected longitudinal position.

13. A control unit, comprising a processor that is configured to carry out the method according to claim 12.

14. A double-deck elevator, comprising:
a shaft; and
an elevator car assembly according to claim 1, wherein the elevator car frame is mounted in the shaft so as to be displaceable between multiple floors.

15. The double-deck elevator according to claim 14, further comprising:
the control unit according to claim 13;
a device for determining the current frequencies of the undesirable vibrations.
